(19) United States
(12) Patent Application Publication
(10) Pub. No.: US 2021/0212425 A1
(43) Pub. Date: Jul. 15, 2021

(54) RETRACTABLE LUGGAGE CASE

(71) Applicant: Shenzhen Xgear Technology Co., Ltd., Shenzhen (CN)

(72) Inventor: Jie Wang, Shenzhen (CN)

(21) Appl. No.: 17/194,309

(22) Filed: Mar. 7, 2021

Related U.S. Application Data
(63) Continuation of application No. PCT/CN2020/076164, filed on Feb. 21, 2020.

(30) Foreign Application Priority Data
Feb. 24, 2019 (CN) 201920226573.4

(51) Int. Cl. A45C 7/02; F16M 13/06

(52) U.S. Cl. CPC A45C 7/02; A45C 13/26; F16M 13/06

(57) ABSTRACT

The present invention relates to a retractable luggage case, comprising a case cover and a case bottom, wherein the case cover and the case bottom are connected by two X-shaped brackets, the X-shaped brackets are respectively located at opposite sides of the luggage case, each X-shaped brackets is comprised of two support rods which are rotatably connected, a rotatably connected connection point is located in a non-midpoint position of the support rods, and the support rods are rotatably or slidably connected to the case cover or the case bottom. The retractable luggage case is further provided with locking structures capable of locking movable ends. A luggage case is formed by buckling a case cover and a case bottom, if the luggage case is unfolded; the case cover is made to form an inclined plane for placing a laptop, thereby being comfortable in use, convenient to carry and practical.

### CROSS REFERENCE TO RELATED APPLICATIONS

The present application is a Continuation Application of PCT Application No. PCT/CN2020/076164 filed on Feb. 21, 2020, which claims the benefit of Chinese Patent Application No. 201920226573.4 filed on Feb. 24, 2019. All the above are hereby incorporated by reference. the contents of which are incorporated herein by reference in their entirety.

### FIELD OF INVENTION

The present invention relates to a luggage case product, and particularly to a retractable luggage case.

### BACKGROUND ART OF THE INVENTION

In modern society, many business people are no longer confined to working in the office, sometimes they turn on laptops at any time to work and deal with business affairs when they are on business trips or outdoors or in coffee houses. For business people, laptops or tablet personal computers are basically carried with them to work outside the office anytime and anywhere. Because it is not convenient to put a laptop on legs while in use, on the one hand, the laptop is supported by soft human legs, which makes the laptop to shake easily or even fall off when typing or putting for a long time, and on the other hand, when the laptop is used for a long time, a temperature of a bottom may be high, making human skin uncomfortable or even burnt, people often use a laptop stand or computer desk to place the laptop so as to meet requirements of using the laptop outdoors or during a journey. However, such laptop stand or computer desk usually occupies a certain space, so when going on a business trip or traveling, it is inconvenient to carry a laptop stand or computer desk specifically, and it is extremely inconvenient to carry a laptop around as well.

### DISCLOSURE OF THE INVENTION

The purpose of the present invention is to overcome the above disadvantages and defects in the prior art, and provide a novel retractable luggage case. The retractable luggage case of the present invention is skillfully designed. A luggage case is formed by buckling a case cover and a case bottom, if the luggage case is unfolded, the case cover is made to form an inclined plane for placing a laptop, which can be used as a laptop desk, thereby being comfortable in use, convenient to carry and practical.

The purpose of the present invention is realized by the following technical solution:

A retractable luggage case, comprising a case cover and a case bottom, wherein the case cover and the case bottom are connected by two X-shaped brackets, the X-shaped brackets are respectively located at a left side and a right side of the luggage case, the X-shaped brackets are foldable brackets, each X-shaped bracket is comprised of two support rods which are rotatably connected, a rotatably connected support rod connection point is located in a non-midpoint position of the support rods, an end of each support rod close to the support rod connection point is set as a rotating end, and the rotating end is rotatably connected to the case cover or the case bottom; and an end of the support rod far away from the support rod connection point is set as a sliding end, the sliding end is slidably connected to the case bottom or the case cover, a distance between the support rod connection point on the left X-shaped bracket and a rotatable connection point of the rotating end on the case bottom is equal to a distance between the support rod connection point on the right X-shaped bracket and a corresponding rotatable connection point of the rotating end on the case bottom, a synchronization rod is arranged between corresponding support rods rotatably connected to the case bottom, the synchronization rod is fixedly connected to the corresponding support rods, and the retractable luggage case is further provided with locking structures capable of locking sliding ends.

In this way, by means of the two X-shaped brackets, the luggage case can be used as a luggage case after closing, and the cover thereof can be used as a laptop stand after opening, so a laptop can be put and used on the cover. The two support rods of each X-shaped bracket are rotatably connected, the connection point thereof is located in the non-midpoint position, and the connection points on the two X-shaped brackets correspond to each other, that is, when the case cover is lifted, stretching amplitudes of the two brackets correspond to each other, so that the left end and the right end have the same height and the left end and the right end have the same movement amplitude, guaranteeing stability when the case cover is opened or closed. The connection points are specially set in the non-midpoint positions of the support rods, so when the case cover is opened, a forward movement amplitude is inconsistent with a backward movement amplitude, and then the case cover is made to form an inclined plane with inconsistent front and back heights, being more comfortable to use when a laptop is placed on the inclined plane. An end of each support rod close to the connection point is set as a rotating end, the rotating end is rotatably connected to the case cover or the case bottom, an end of the support rod far away from the rotatable connection point is set as a sliding end, and the sliding end is slidably connected to the case bottom or the case cover. A distance between the rotatably connected connection point on the left X-shaped bracket and a rotatable connection point of the rotating end on the case bottom is equal to a distance between the rotatably connected connection point on the right X-shaped bracket and a corresponding rotatable connection point of the rotating end on the case bottom. A synchronization rod is connected between rotating ends connected to the case bottom, and the rotating ends are rotatably connected to the case bottom through the synchronization rod. In this way, short sides of the support rods are set as rotating ends, the rotating ends are rotatably connected to the case cover and the case bottom, and the rotating ends are connected by the synchronization rod, guaranteeing the two X-shaped brackets to synchronously move and form an inclined plane. Long sides of the support rods are set as sliding ends, which makes a stroke farther. The sliding ends can be locked during sliding by the locking structures capable of locking sliding ends, so the sliding ends can be locked or released as required, being more convenient to adjust the height of the case cover.

Another preferred solution of the present invention is: a synchronization rod is connected between the rotating ends connected to the case cover, the rotating ends are fixedly connected to the synchronization rod, and then the synchronization rod is rotatably connected to the case cover. By means of the two synchronization rods, shaking during opening or closing is avoided, so the stability and synchronization of movement during opening or closing the case cover can be further enhanced.

Another preferred solution of the present invention is: the case bottom is formed by two flat plates which are hinged. The case bottom plate is formed by two flat plates which are hinged by hinges specifically, that is, the flat plates can rotate downwards, but cannot rotate upwards, and the hinging joints can be arched upwards when the flat plates rotate downwards, being more comfortable to use on legs.

Another preferred solution of the present invention is: the case cover is provided with a blocking piece. The blocking piece is arranged at the end where the case cover is connected to the short side of the support rod, because this end is a lower end of the inclined plane when the case cover is opened, and the blocking piece is arranged on the case cover to prevent the laptop from slipping off, being more stable when the laptop is used.

Another preferred solution of the present invention is: the case cover is further provided with a storage layer, the storage layer being a cloth bag attached to the case cover. The storage layer may contain some articles such as power adapter, wallet and the like.

Another preferred solution of the present invention is: the case bottom is provided with a storage cavity. The storage cavity may contain laptop or other luggage to be carried.

Another preferred solution of the present invention is: a stretchable Mouse board is arranged at one side of the case bottom, when the laptop is used, the Mouse board is pulled out, and the Mouse of the laptop is put on the mouse board, being more comfortable and convenient to use.

Another preferred solution of the present invention is: the case cover is provided with a stretchable mobile phone clip. When using a laptop desk, a mobile phone is placed on the mobile phone clip, so that the mobile phone can be operated at any time.

Another preferred solution of the present invention is: the case cover is further provided with an elastic bag. The elastic bag can contain small articles.

### DESCRIPTION OF THE DRAWINGS

FIG. 1 is a first structural schematic diagram of a retractable luggage case in embodiment 1 of the present invention.

FIG. 2 is a structural schematic diagram of X-shaped brackets of a retractable luggage case of the present invention.

FIG. 3 is a second structural schematic diagram of a retractable luggage case in embodiment 1 of the present invention.

FIG. 4 is a third structural schematic diagram of a retractable luggage case in embodiment 1 of the present invention.

FIG. 5 is an amplified structural schematic diagram of a locking structure in embodiment 1 of the present invention.

FIG. 6 is a structural schematic diagram of a retractable luggage case in embodiment 2 of the present invention.

### DETAILED DESCRIPTION OF THE INVENTION

Some preferred embodiments of the present invention are provided below in order to further understand the present invention.

### Embodiment 1

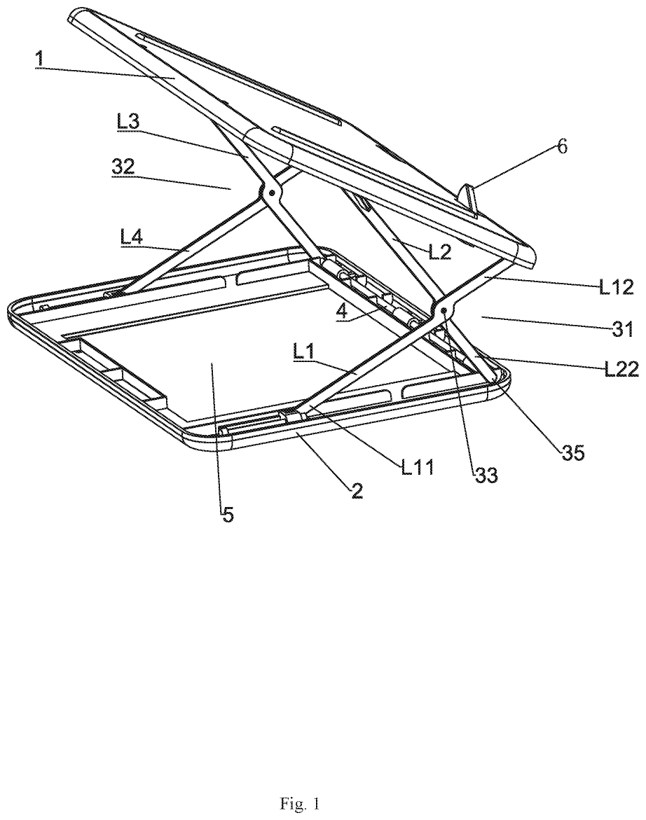

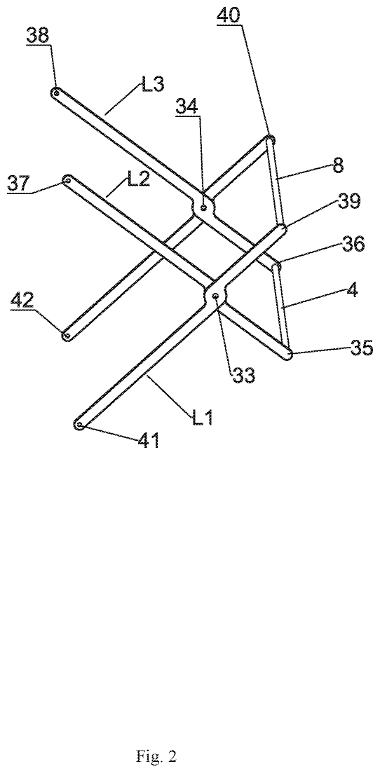

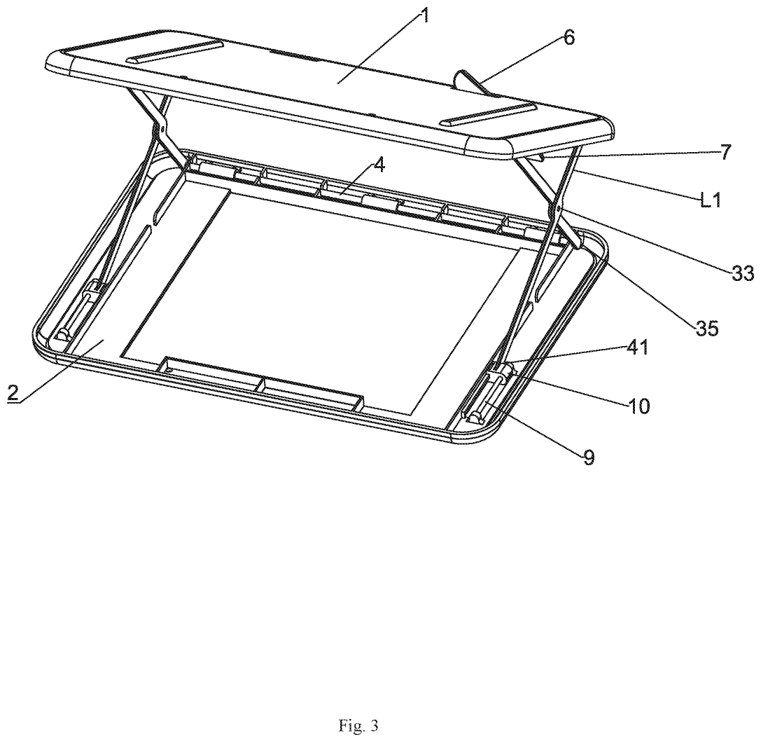

This embodiment is one of preferred embodiments of the present invention. FIG. 1 is a structural schematic diagram of a retractable luggage case in embodiment 1 of the present invention. FIG. 2 is a structural schematic diagram of X-shaped brackets of a retractable luggage case of the present invention. FIG. 3 is a second structural schematic diagram of a retractable luggage case in embodiment 1 of the present invention.

As shown in FIG. 1, FIG. 2 and FIG. 3, a retractable luggage case, comprising a case cover 1 and a case bottom 2, wherein the case cover and the case bottom are connected by two X-shaped brackets 31 and 32, the X-shaped brackets are respectively located at a left side and a right side of the retractable luggage case, the X-shaped brackets are foldable brackets, each X-shaped bracket is comprised of two support rods which are rotatably connected (that is, the left X-shaped bracket 31 is comprised of a support rod L1 and a support rod L2 which are rotatably connected, a connection point 33 is a connection point of the two support rods L1 and L2; the right X-shaped bracket 32 is comprised of a support rod L3 and a support rod L4 which are rotatably connected, a connection point 34 is a connection point of the two support rods L3 and L4, that is, the X-shaped brackets are folded or unfolded by rotating the support rods around the connection points, so that the case cover and the case bottom are closed or opened, and then the luggage case becomes a retractable luggage case). The rotatably connected connection point 33 is located in the non-midpoint position of the support rods L1 and L2, the rotatably connected connection point 34 is located in the non-midpoint position of the support rods L3 and L4, and an end of each support rod close to a rotatable connection point is set as a rotating end. As shown in FIG. 1, FIG. 2 and FIG. 3, a long end (i.e. from the connection point 33 to an end point 41) of the support rod L1 is set as a sliding end, the end point 41 of the sliding end is rotatably connected to a sliding block 10 of the case bottom, the sliding block is sleeved on a guide rail 9 to slide, the guide rail is fixed to the case bottom (correspondingly, end points 37, 38 and 42 of long ends of the support rods L2, L3 and L4 are also correspondingly connected to the case cover and the case bottom according to this mode), an end point 39, of a short end of the support rod L1, i.e. an end close to the rotatable connection point 33, which is a rotating end, is rotatably connected to the case cover, a distance between the rotatably connected connection point 33 on the left X-shaped bracket and a fixed connection point 35 on the case bottom is equal to a distance between the rotatably connected connection point 34 on the right X-shaped bracket and a corresponding rotatable connection point 36 of the rotating end on case bottom, a synchronization rod 4 is connected between the rotating ends connected to the case bottom, a synchronization rod 8 is connected between the rotating ends connected to the case cover, both the synchronization rod 4 and the synchronization rod 8 are fixedly connected to the end points (end points 35, 36, 39 and 40 shown in FIG. 2) of the short ends of the support rods, the synchronization rods are rotatably connected to the case cover or the case bottom, that is, the synchronization rods are round rods, and are fastened to the case cover or the case bottom by corresponding hinges, the retractable luggage case is further provided with locking structures 7 capable of locking sliding ends, the case bottom is provided with a storage cavity 5, and the case cover is provided with a blocking piece 6.

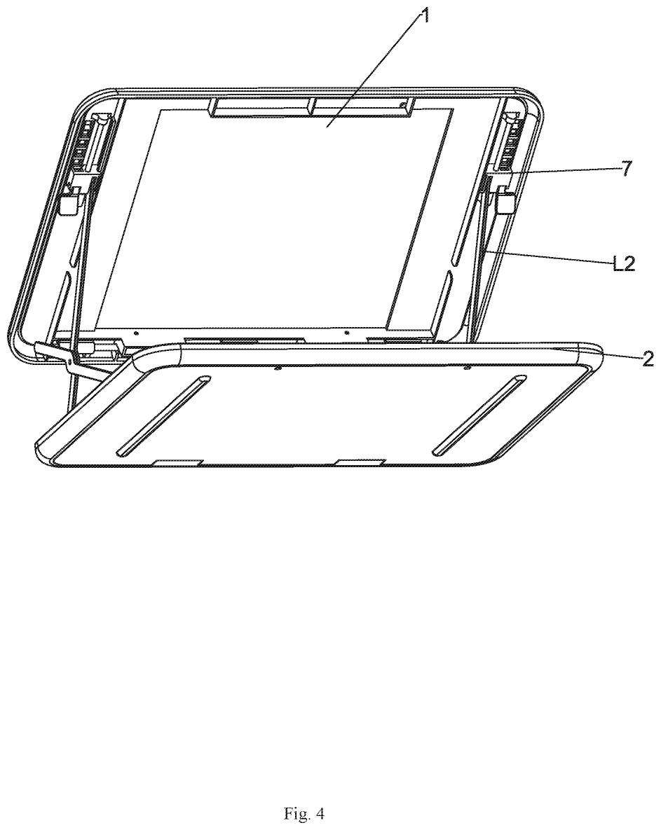

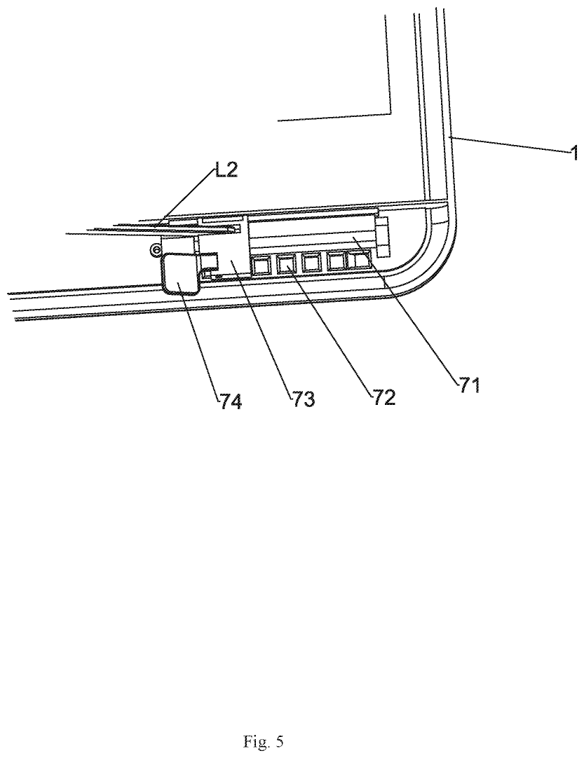

FIG. 4 is a third structural schematic diagram of a retractable luggage case in embodiment 1 of the present invention. FIG. 5 is an amplified structural schematic diagram of a locking structure in embodiment 1 of the present invention. As shown in FIG. 4 and FIG. 5, locking structures in this embodiment are arranged on side surfaces of the case cover, an end point 37 of a long end of the support rod L2 is rotatably connected to a sliding block 73, a locking structure 7 comprises a pressing handle 74, the sliding block 73, a case cover guide rail 71 and a hole groove 72, wherein the case cover guide rail is fixed to the case cover, the sliding block is sleeved on the case cover guide rail, the pressing handle is provided with a clamp which can be clamped in the hole groove, the pressing handle is rotatably connected with the sliding block, when the pressing handle is pressed, the clamp is pulled out of the hole groove, equivalent to when the locking structure is released, the sliding block can drive the support rod L2 to slide along the case cover guide rail 71, and when sliding to a required point, the pressing handle is released, the clamp is clamped into the hole groove, and the sliding block is locked. The restoration of the pressing handle may be implemented by restoring force provided by arranging a spring or a clamping spring under the pressing handle or arranging a damping mechanism.

### Embodiment 2

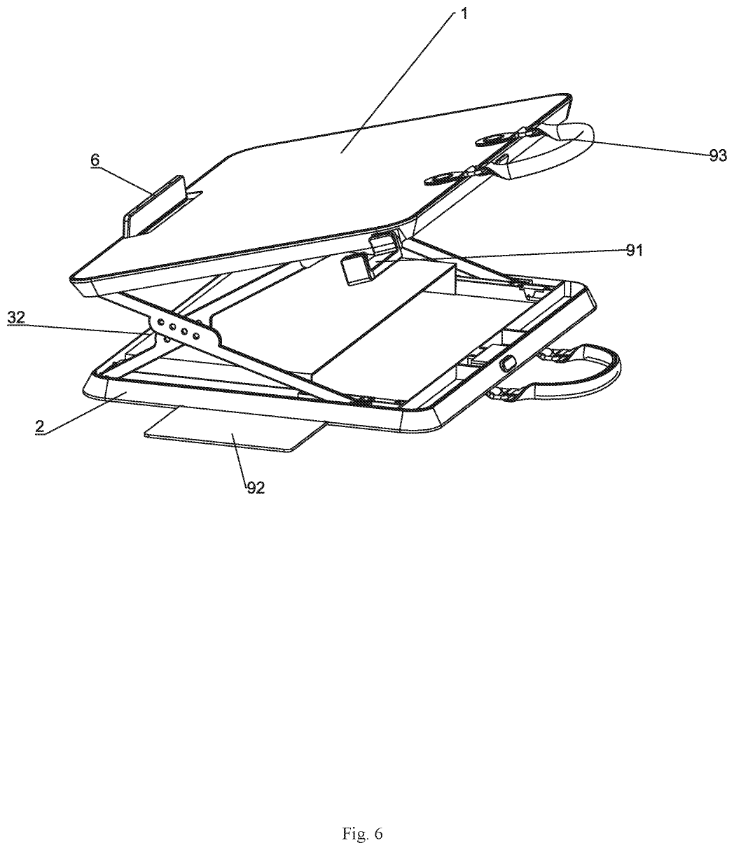

Embodiment 2 is another implementation of the present invention. FIG. 6 is a structural schematic diagram of a retractable luggage case in embodiment 2. As shown in FIG. 6, based on embodiment 1, as an improved solution, the case bottom 2 is formed by two flat plates which are hinged. Moreover, a stretchable Mouse board 92 is arranged at one side of the case bottom, the case cover and the case bottom are respectively provided with a lifting handle 93, and the case cover is provided with a stretchable mobile phone clip.

When the present invention is used at ordinary times, a laptop is put in a storage space of the case bottom, the case cover is opened to take out the laptop while in use, because the connection points of the support rods of the brackets are located in non-midpoint positions, the case cover is made to form an inclined plane to be used as a laptop desk, which can be placed on knees, and can be placed on a small tea table or desk. The X-shaped brackets used in the present invention completely separate the case cover from the case bottom when the case cover is opened, so that a desk top is greatly uplifted in height, and meanwhile, the case cover is made to form an inclined plane by such brackets, being more convenient to use the laptop and being practical.

The above embodiment is a preferred implementation mode of the present invention. However, the implementation mode of the present invention is not limited by the above embodiment. Any other change, modification, replacement, combination and simplification made without departing from the spiritual essence and principle of the present invention shall be equivalent substitution mode, and shall be included within the protection scope of the present invention.

What is claimed is:

1. A retractable luggage case, comprising a case cover and a case bottom, wherein the case cover and the case bottom are connected by two X-shaped brackets, the X-shaped brackets are respectively located at a left side and a right side of the luggage case, the X-shaped brackets are foldable brackets, each X-shaped bracket is comprised of two support rods which are rotatably connected, a rotatably connected support rod connection point is located in a non-midpoint position of the support rods, an end of each support rod close to the support rod connection point is set as a rotating end, and the rotating end is rotatably connected to the case cover or the case bottom; and an end of the support rod far away from the support rod connection point is set as a sliding end, the sliding end is slidably connected to the case bottom or the case cover, a distance between the support rod connection point on the left X-shaped bracket and a rotatable connection point of the rotating end on the case bottom is equal to a distance between the support rod connection point on the right X-shaped bracket and a corresponding rotatable connection point of the rotating end on the case bottom, a synchronization rod is arranged between corresponding support rods rotatably connected to the case bottom, the synchronization rod is fixedly connected to the corresponding support rods, and the retractable luggage case is further provided with locking structures capable of locking sliding ends.

2. The retractable luggage case according to claim 1, characterized in that a synchronization rod is connected between support rods rotatably connected to the case cover.

3. The retractable luggage case according to claim 1, characterized in that the case bottom is formed by two flat plates which are hinged.

4. The retractable luggage case according to claim 2, characterized in that the case bottom is formed by two flat plates which are hinged.

5. The retractable luggage case according to claim 1, characterized in that the case cover is provided with a blocking piece.

6. The retractable luggage case according to claim 2, characterized in that the case cover is provided with a blocking piece.

7. The retractable luggage case according to claim 1, characterized in that the case cover is further provided with a storage layer, the storage layer being a cloth bag attached to the case cover.

8. The retractable luggage case according to claim 2, characterized in that the case cover is further provided with a storage layer, the storage layer being a cloth bag attached to the case cover.

9. The retractable luggage case according to claim 1, characterized in that the case bottom is provided with a storage cavity.

10. The retractable luggage case according to claim 2, characterized in that the case bottom is provided with a storage cavity.

11. The retractable luggage case according to claim 1, characterized in that a stretchable Mouse board is arranged at one side of the case bottom.

12. The retractable luggage case according to claim 2, characterized in that a stretchable Mouse board is arranged at one side of the case bottom.

13. The retractable luggage case according to claim 1, characterized in that the case cover is provided with a stretchable mobile phone clip.

14. The retractable luggage case according to claim 2, characterized in that the case cover is provided with a stretchable mobile phone clip.

15. The retractable luggage case according to claim 1, characterized in that the case cover is further provided with an elastic bag.

16. The retractable luggage case according to claim 2, characterized in that the case cover is further provided with an elastic bag.
